(19) United States
(12) Patent Application Publication
(10) Pub. No.: US 2018/0113862 A1
(43) Pub. Date: Apr. 26, 2018

(54) Method and System for Electronic Document Version Tracking and Comparison

(71) Applicant: Workshare, Ltd., London (GB)

(72) Inventor: Robin Glover, Harwell (GB)

(73) Assignee: Workshare, Ltd., London (GB)

(21) Appl. No.: 15/819,640

(22) Filed: Nov. 21, 2017

Related U.S. Application Data
(63) Continuation-in-part of application No. 14/980,173, filed on Dec. 28, 2015.
(60) Provisional application No. 62/424,811, filed on Nov. 21, 2016.
(60) Provisional application No. 62/097,190, filed on Dec. 29, 2014.

(51) Int. Cl. G06F 17/30; G06F 17/22; G06N 5/04; G06T 11/20

(52) U.S. Cl. CPC G06F 17/3023; G06F 17/30011; G06F 17/30368; G06F 9/4443; G06N 5/04; G06T 11/206; G06F 17/2288

(57) ABSTRACT

A computer system adapted to use a variety of strategies to automatically build and maintain version trees for document files that are versions of a document, and display such information to users in order that users comprehend the evolution and history of the document.

### PRIORITY CLAIM

This is a utility patent application. This application claims priority as a non-provisional continuation of U.S. Pat. App. No. 62/424,811, filed on Nov. 21, 2016. This application is a continuation-in-part to U.S. patent application Ser. No. 14/980,173, filed on Dec. 28, 2015, which is a non-provisional application of U.S. Patent Application No. 62/097,190 filed on Dec. 29, 2014, both of which are herein incorporated by reference in their entireties for all that they teach.

### FIELD OF INVENTION

The invention comprises of a personal document scanning and search system which will scan and index a user's documents across a broad range of storage systems that may include email, local disks, Document Management Systems (DMS) and online file sharing and editing systems. Additionally, the system uses a variety of strategies to build data structures organized as version trees for documents, helping the user understand the evolution and history of a documents as it is revised into different versions of the document. The invention describes a user interface which the allows the user to interact with and gain information from the system. This user interface may be displayed as a stand-alone application or as an add-in to one or more existing productivity applications such as Microsoft™ Outlook™, Microsoft Word™, or similar office productivity tools. Displaying the user interface as an add-in to an existing productivity applications allows timely information to be displayed to the user—such as informing the user that the user is editing an out-of-date version when they begin editing a file using the productivity application.

### BACKGROUND

In many business situations, it is common for multiple versions of one or more documents to be created. Some businesses use tools such as Document Management Systems (DMS) or other content repositories to try to track and store each version of the document that is created. Even when such systems are in use, versions tend to be created and/or stored in locations outside the DMS when copies of the document are sent by email, received from 3rd party contributors, copied for offline editing, etc. The problem is becoming more severe as the number of possible places where documents and their versions can be stored grows. For instance documents may be stored and/or shared online using products or on-line services such as Google Docs™ or Google Drive™, Microsoft Office 365™ or Microsoft OneDrive™, Workshare Connect™ and many others are examples of remote file storage and file sharing systems. In this manner, a document data file representing a version of a document is associated with a repository location that can range from a location designated by the local file system directory to the location of stored email messages comprised of the file as an attachment to locations designated by the DMS or even locations designating the URL of an external on-line file storage and sharing system that is accessed through an API or by means of including with the URL a slug string in order to access the file across the Internet.

This can be a particular problem for workers and businesses—such as lawyers and law firms—who deal with many clients where each client may require that a particular, different, online system is used for storage or sharing of their documents for that client's work. In such a situation, the documents that make up a single employee's workload may be spread over as many as 10 or even more systems because that employee is handling work for a diverse set of clients with a diverse set of document storage repositories.

This problem is most acute for document formats that encourage editing (such as Microsoft™ Office™ format documents) as opposed to document formats which are largely used for presentation of a final copy (such as Adobe™ PDF documents).

The problem facing a document author or collaborator is often this: having received or found a new version of a document, how do they decide what to do with it? Was the version of a document that has arrived in an email message or has been shared with them created by editing the most recent version stored in the DMS? Was it created by editing an older version of the document? Is it just a duplicate of some other version of the document? Depending on the answers to these questions, different actions are required—for instance in the first case of the document being created by editing the latest DMS version it is likely enough just to save the received version as a new version into the DMS. In the second case, it is likely that the changes made to the received version need to be merged into the latest DMS version, while in the last case no action at all may be required.

Therefore, there is a need for a software tool or system capable of helping the user understand the relationships between the different versions of the documents they are working on and find the locations and history of those versions, helping to avoid common time-wasting slip ups such as applying edits to the wrong version of the document or embarrassing errors such as sending an out-of-date version of a document to clients as the current revision.

Existing software is insufficient to fill this need—content management systems such as DMS systems track versions of the document stored on their systems but do not consider anything that occurs outside of their limited domain—such as upload to online sharing portals or copies on local folders or attached to email messages. Search tools may be able to find documents by name, keyword or content but have no understanding of the relationships between different versions of a document. In general multiple search tools would need to be employed to search local files, email, DMS and online file sharing repositories, making the process burdensome for the user. Thus, there is a need for a method and system that can determine the genealogy of a specific version of a document.

The invention describes a software system with a number of key components including:
A number of repository scanners—each scanner being a code module that when executing as operates the task of scanning one or more repositories of content for new and changed documents. Examples of repositories might include the:
   ‘My Documents’ folder or other folders on the local computer;
   The contents of an Email account or accounts;
   The contents of a DMS system (limited by user permissions);
   The contents of (or a folder on) a network shared driver;
   The contents of an online file sharing or collaboration account.
A database to store information about copies of documents found by the scanning step in the various repositories that are scanned and other information derived by or used by the system.
An inference engine component which is a code module that when executing uses one or more encoded inference rules to determine version genealogy of documents found by the repositories scanners. More details of the inference engine are given below.
A re-purposing detection engine which is a code module that when executing uses one or more re-purposing detection logic rules to identify situations where a document has been re-purposed into a new context and thereby departed from one particular document genealogy (also referred to as “hierarchy”) to another.
A display component that is a code module that when executing, displays the information gathered by the scanner, the inference engine and re-purposing detetion enging about documents and their versions to the user in various contexts.
A controlling component that ensures all of the above components are run as and when required.

### DESCRIPTION OF THE FIGURES

The headings provided herein are for convenience only and do not necessarily affect the scope or meaning of the claimed invention. In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 101 is first introduced and discussed with respect to FIG. 1).

FIG. 1 shows the basic system architecture

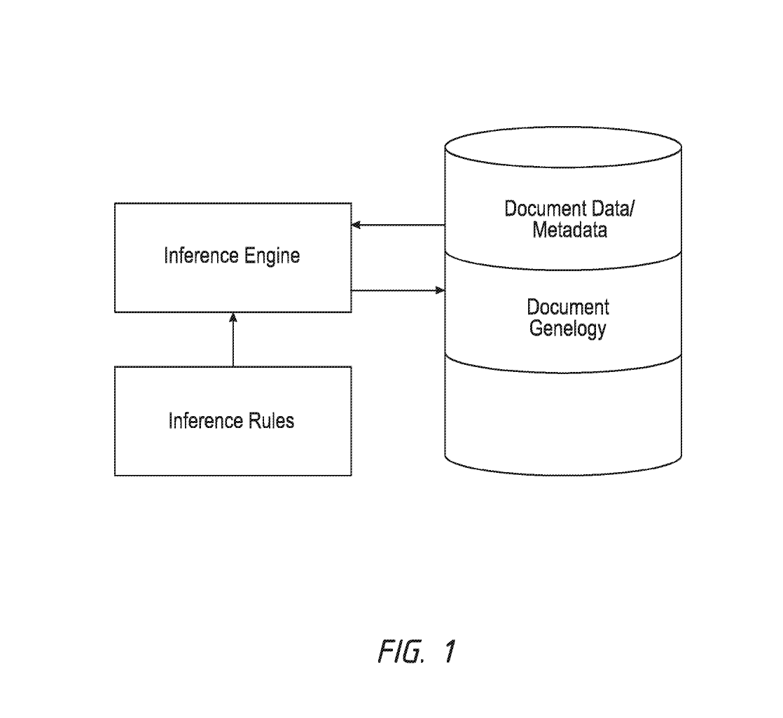

FIG. 2 shows the basic flowchart for detecting the repurposing of a document and creating a new hierarchy.

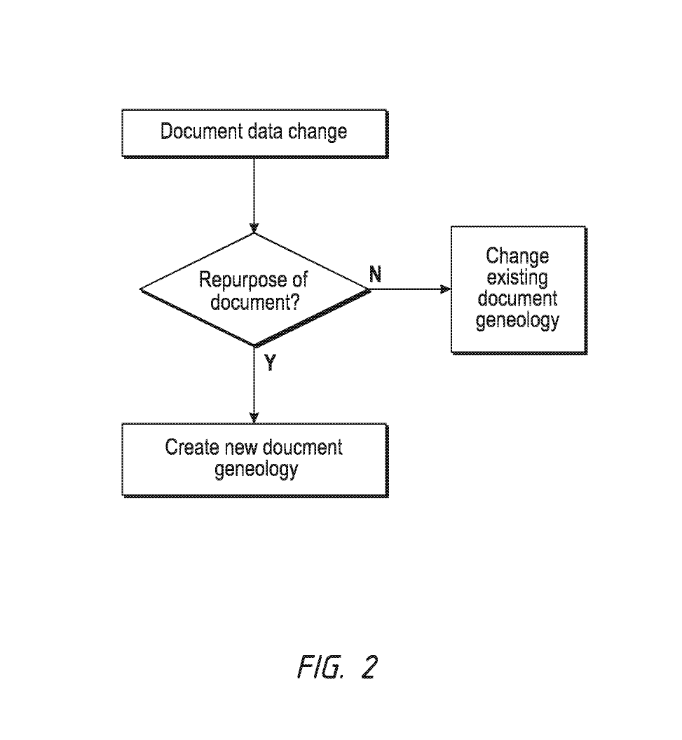

FIG. 3 shows a more detailed flowchart for repurposing.

FIG. 4 shows the processing of a file to insert it into the hierarchy with version numbers.

FIG. 5 shows an exemplary data structure element for defining the hierarchy.

FIG. 6 shows an exemplary hierarchy that shows a branching of the versions of the document.

### DETAILED DESCRIPTION

Various embodiments will now be described. The following description provides specific details for a thorough understanding and enabling description of these examples. One skilled in the relevant art will understand, however, that the invention may be practiced without many of these details. Likewise, one skilled in the relevant art will also understand that the invention can include many other features not described in detail herein. Additionally, some well-known structures or functions may not be shown or described in detail below, so as to avoid unnecessarily obscuring the relevant description. The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

### Repository Scanners:

The repository scanners provide generic and abstracted access to a wide range of content repositories, allowing new content repositories to be added to the solution without needing to make significant changes to the code of the rest of the product. The scanners hide implementation details of the content repositories behind a common user interface. Each repository scanner has to perform a number of major tasks:
1) Perform an initial scan of the content within the repository when the software is first used in order to index existing documents. The content that is discovered is separated into two categories—files and containers. A container is anything that holds a file—for example a folder or directory, in the case of a repository scanner that is scanning a file system or an email, text message or other electronic message in the case of a repository scanner that is scanning an email system or other electronic messaging system (in this case the file would be an attachment to an email).
2) Provide or obtain metadata information about content (files and containers) that are scanned. This context information may include data such as the timestamp indicating when the content was created or changed, a list of people connected to the content and their roles. For example, metadata may include: sender and recipients of an email message, the author of the document or author of the modifications of the document, the folder location that the document was found, and the repository where that folder was located.
3) Provide updates to the metadata when new content is added to the repository or when content is changed. If the repository itself supports sending notification messages when an update occurs then the repository scanner may be configured to receive and use such messages as its source of information, otherwise it may poll the content of the repository periodically and look for changes.
4) Provide access to the content of files in the repository for other components that need to extract data from those files
5) Provide access to a user interface that is displayed on a computer, either as a webpage or as an application user interface that presents the container in which a file is located when such container is selected for display based on user input of selections. To open a folder into the operating systems file system explorer application or to select and display a particular email message or other electronic message. When the user makes any of these selections, the invention is triggered to display information about the file or folder or message (i.e. the file or container).
6) Provide a function to open a selected file as a result of the user selecting a command to open a particular file of a file type into a default application associated with that file type.
   The details of how these tasks are implemented will depend on the nature of the repository that the scanner targets.

### Database:

In one embodiment, the invention is embodied in a computer program operating for a specific user, that is it may operate on a single computing device (currently a Windows™, MacOS™ or Linux™ computer). In this version of the system, the database stores only data for a single user associated with the computer the program is running on. The database may be stored on that computer, or alternatively, stored remotely and accessed by such computer. In other versions of the system, the database may be stored online and shared across multiple users. This would increase complexity but not fundamentally alter the nature of the data stored in the database or the functionality of the system as a whole.

The database itself may be a relational database (for instance SQL Server, SQLite, etc.) or a non-relational database such as a graph database or another NoSQL database. The primary data stored in the database is the results of scanning each content repository. Details on files and containers are stored in the database including basic file details such as name, size, location, timestamp and a cryptographic hash (for example md5 or SHA1) of file content to allow duplicate copies to be detected easily. When the scanner detects that two files of two different names have identical hashes, it can store metadata indicating that they are duplicated copies of the same version of the same document. Additional context and metadata information is added to the database when each container or file is scanned or if a file is modified, or a new version of a document is stored or a new document is received. This information—for example the sender, recipients and subject of an email message, the permissions list for an online folder or specific metadata extracted from the content of a document file are stored in the database in data records associated with the file and further form the input information to the Inference Engine to allow it to determine document version genealogy and to the user interface component to allow the history of the document to be correctly displayed.

Note that when a file is modified in a repository (for instance a file on disk is edited), a new file entry in the database is created to record information about the newly changed content—any existing entries in the database describing older versions of that file at the same disk location are left intact and are not overwritten. This is because the goal of the system is to not simply record the state of the user's documents at the current point in time but also to be able to display information about how the documents have changed over time.

Secondary data stored in the database includes the data that represents the document genealogy derived by the Inference Engine. Storing this data in the database avoids having to recalculate the full genealogy of all documents when new versions are added. When a new version of a document is created, the new data record for that version includes reference information to the version of the document that was opened in order to create the new version. The genealogy (or hierarchy) for each document consists of a number of versions (each of which may have parent and/or child versions). Each version represents a particular snapshot of the documents content identified by a single cryptographic hash value of the document content. In other embodiments a checksum may be used. Each version may be associated with multiple files (i.e. the system may have found multiple identical copies of the document in different places). All of the above information may be stored in a data record associated with the specific version of the document. Typically, each specific version of a document is a specific data file of a file type. In some cases, due to work flow, a document may be opened as one file type and then stored as another. As a result the metadata may also include the file type associated with that version of the document.

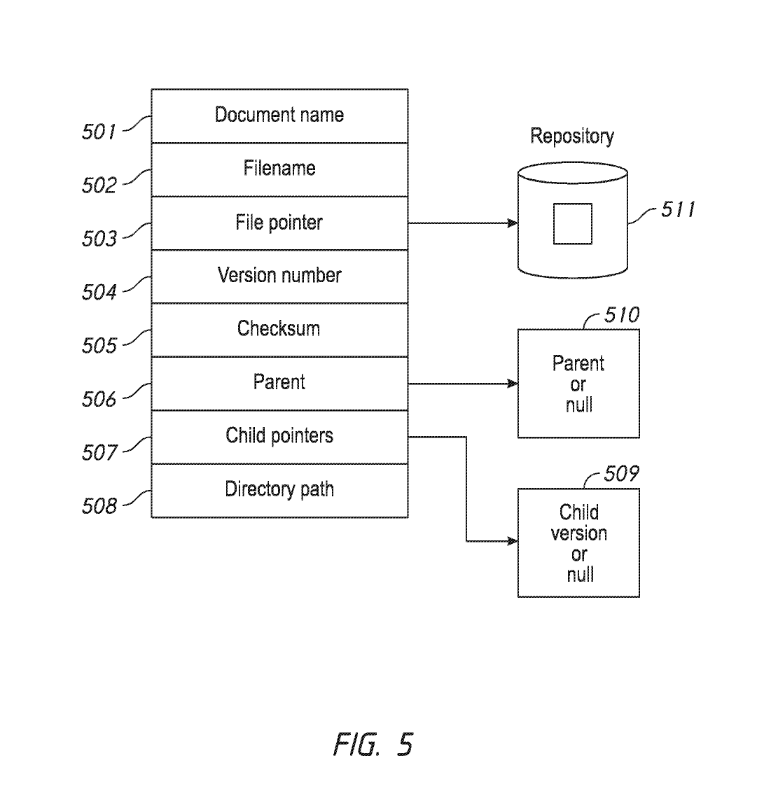

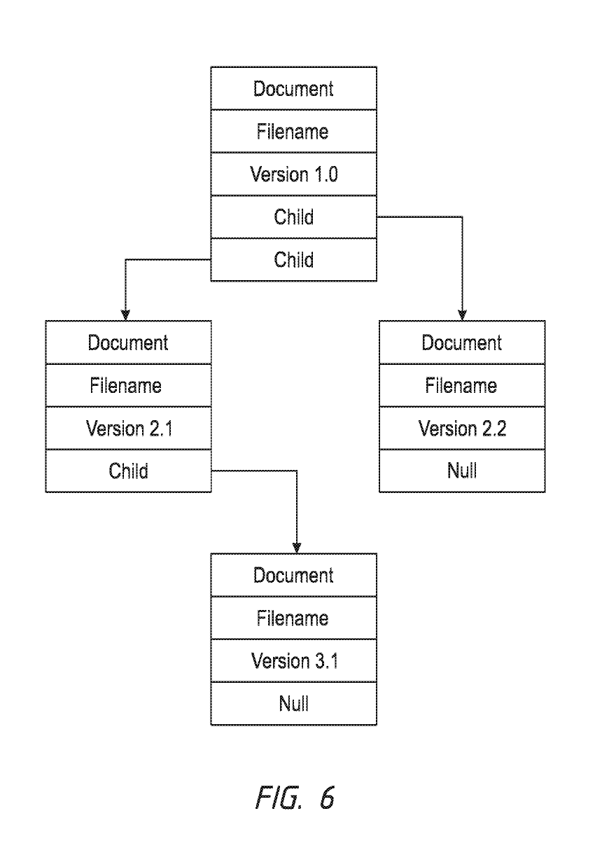

One exemplary embodiment of an element in a datastructure representing the version hierarchy is presented in FIG. 5. In this structure, each element in the hierarchy has the same “Document Name” because that refers to the family of versions. For example, a document name could be “Whiteacre Stock Purchase Agreement.” (501) Each version of that agreement document would typically have a different filename (or if the same filename, a different directory). For example, an author may save a new version of the agreement as “WhitacreSPA”, which would appear in the data element (502). The table would include pointer (503) to the data resource or data repository (511) where the file can be recovered. That file may have a version number relative to the original, (504). The checksum or hash of the file data is calculated and then stored in the data element (505). As the version hierarchy is developed, a pointer to a data element corresponding to the parent version (510) is inserted, or is NULL for the original document. (506). When a new version of the Document is discovered or created, and it is the next version relative to this version, a pointer to the data element for that child version (509) is inserted into the data element (507). If this version of the document is the latest in the line, then that value is NULL. An example result result is a hierarchy that is presented in FIG. 6. In FIG. 6, there are two lines in the geneology, which demonstrate possible version conflict.

Where a file has been detected as being re-purposed rather than a new version by the re-purposing detection component, this information is also stored in the database so that future invocations of the Inference Engine can avoid re-detecting the file as a new version and instead place that version in the genealogy of a new document. Typically, the re-purposed document is the earliest ancestor of a new document genealogy. Finally, the database may be used to store configuration data for the system—for instance folders or email accounts to be scanned, access tokens or encrypted password information to allow access to online storage APIs. In this embodiment, a given file, which is a version of a document, may have a data record in the database that includes its location and any passwords or access tokens required to obtain access to the file.

### Inference Engine

The inference engine interrogates the database for details of scanned files that have not yet been successfully placed in a version hierarchy. Each of these unplaced files are then evaluated by the inference engine against other unplaced files and also against existing files that are already placed into version genealogies to determine if they are an as-yet seen new version of another document already in the database or an entirely new family.

Multiple inference rules are applied by the inference engine when testing each possibility, and each inference rule calculates a score value of how likely it is that the unplaced file being examined is connected to a particular document version hierarchy. If the total score for a particular connection summed across all inference rules exceeds a threshold value, then the unplaced file is connected to the document version hierarchy. This approach allows the use of inference rules that detect a likelihood of a connection rather than a certainty—if multiple rules suggest a likelihood of the same connection then the connection is used. There are a variety of techniques that may be used to test the connectedness or relatedness of two document files. These tests can include:
The two filenames are identical: “Whiteacre SPA” vs “Whiteacre SPA”
The two filenames utilize mostly the same text strings: “Whiteacre SPA 9 23 17” vs “Whiteacre SPA 11 11 17”
The two files have the same important keywords in proximity:
   “by Whiteacre, Inc. (the “Seller”)” vs. “by Whiteacre, Inc. (the Seller).
The author metadata associated with the file is by the same authors.
   Owner=“Anne Smith, Esq” vs Comment author=“Anne Smith, Esq”.
The file is received in a group of files in the same email or other transmission that includes the other file.
The file is received from an email address associated with a recipient of the other file.
   These tests can be encoded using Boolean logic that is applied to the metadata stored in association with the files themselves. A predetermined weighting factor can be applied to the binary test result of each Boolean expression, and then the linear combination being calculated a score output.

As well as calculating a score for each possible connection, inference rules also calculate where in an existing version hierarchy the new file should be placed—i.e. which version (if any) is the parent version of the new file and which versions (if any) are the likely child versions of the new file. This is important to deal with cases of older versions of files being discovered by the system after newer versions (perhaps when a new content repository is added or during the initial scan).

When the inference engine determines that a file is a version of a particular document, that information, including information about parent and child versions, is stored in the data record associated with the version that is in the database, allowing the version hierarchy of documents to be built up over time as more versions are discovered by the repository scanners.

In the case where the combined score for a particular connection fails to meet the normal predetermined threshold for the score value but is greater than a second, lower, predetermined threshold score value, the details of the connection may be stored in the database as a potential link, which will cause the user interface to present to the user with a question at some later point in time asking them to confirm whether the file is a new version of a that particular document or not.

The different inference rules may be assigned different weights based on the strength of evidence that they represent, and that a particular inference rule may give either a fixed score or a variable score in the case where the rule itself can evaluate the strength of the evidence it finds. For example in the rule regarding a returned email (para 24, below) an alternative embodiment would define a rule that allows for the filenames to be similar instead of matching—this alternative version would give a lower score than the version where the filenames match. Indeed the alternative version may give a variable score depending on how similar the filenames are, with more similar filenames giving a higher score.

### Inference Rules

The inference engine makes use of a number of inference rules which determine whether a particular file is related to some other file or group of files by being a different version of the same document. A very simple inference could be described as follows:
If the file under test has the same location (file system path) as a file scanned before and has a newer modify timestamp and different content then the file under test is highly likely to be a new version of the file we scanned before at the same location.

In Boolean logic, it may be expressed using certain data structures that represent information about the files. For a file under test, F1, it may be represented by an element in a data structure. The first entry in the element, F1.pointer, may be a pointer or other reference to the location of the file. Other entries may include a directory string representing its location in the file system structure, e.g. F1.directory. The scanned file F2, also has a representative data structure element, also with a reference or pointer to its location, F2.pointer, and some kind of directory string representing its location in the file system architecture, F2.directory. In some embodiments, the two entries may be same thing. The entries for the files may include their creation date, F1.creation, modification date, F1.modification, author, F1.author, or most recent author. In addition, the checksum may be stored in the data structure, so there would be an F1.checksum and F2.checksum. Similarly, the data structure elements may include a version number for the document, so: F1.version. The data structure representing the file version hierarchy may be a linear array, or a linked list, where each element representing one version has pointers to its predecessor or successor, as lineal ancestors and descendants. So, for one file, F1, it may have a pointer F1.parent and a pointer F1.child. If there is not predecessor, the value would be NULL, or if no successor, NULL (respectively). The use of pointers makes possible a tree structure representation of the hierarchy, whereby the element in the data structure may have an additional element for each successor branch of the document versions, that is, that there may be more than one child pointer. In this case, the version number, can be designed so that the version takes into account which branch in the tree that the successor version is located. For example, there may be F1.version=1, but the file F2.version that is a child file on the first branch may be designated: F2.version=2.1, while a file F3 on the other branch as F3.version=2.2. An example tree structure of the hierarchical data structure is shown in FIG. 6. In this case, two documents may be related but neither is a lineally related such that one is a lineal ancestor or descendant of the other

Give the above structure there can be a boolean test expressed in peudo-code:

If (F1.directory=F2.directory and F2.modification>F1.modification and F1.checksum < >F2.checksum) then F2.version=F1.version+1; else go to next file. The symbol < > denotes the “does not equal” operator.

Given a set of files that are versions of the same document, if this type of rule is applied to all pairs of files, the version sequence will be correct. However, another process may have to be implemented which is for each increments F2.version, any later version numbers after that would have to be incremented too.

This Boolean rule would set the version number for file F2 to be incremented by one over the version number of F1. The data structure with the version numbers can be processed by sorting algorithms to assign the version numbers in accordance with the logic. For example, using sorting techniques that manipulate pointers from one data structure element to another may be used in order to take a set of un-sequenced files and set their pointer structure and version numbering in order. Similarly, sorting algorithms for populating a tree-structured data organization may be used when a new file is scanned to determine its location in the hierarchy.

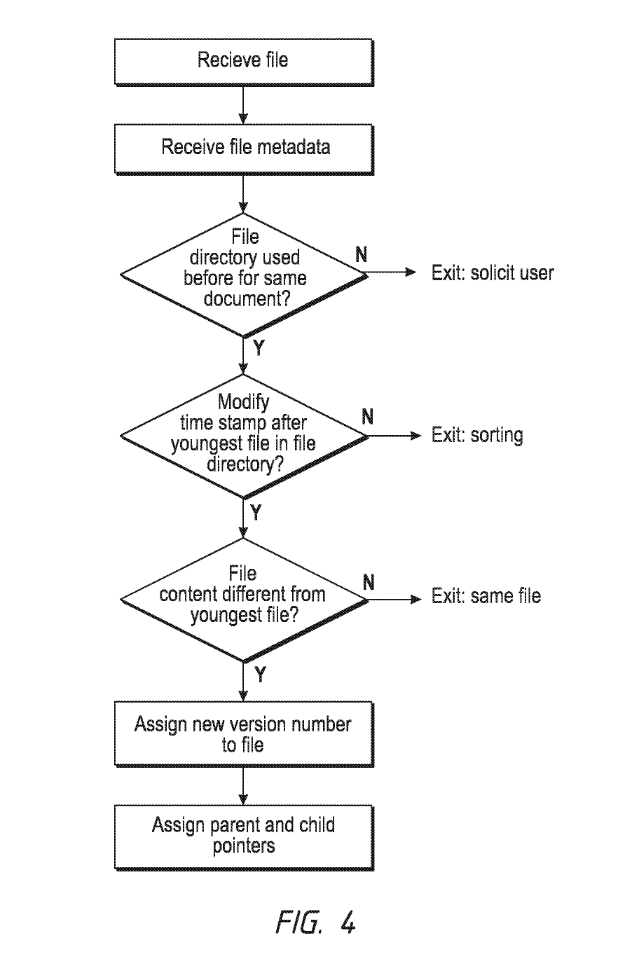

An exemplary flow chart of the initialization process is shown in FIG. 4. In this case, a new file is either created or located for scanning. The available metadata for that file is also recovered, for example, its modification date and its hash or checksum. Other metadata may include the one or more authors associated with originating or modifying the document, creation date, file system directory location, information about transmission or receipt of the file, and the identity of other files that have been modified by the same author around the same period of time as the modifications to the document. In addition, the user may be saving the file to a particular directory, or a directory located by matching the filename or document name associated with the file. If the file directory has been used before for the same document, then the modification time stamp is checked against documents in the same directory to see if this document is the youngest. If so, then the content is checked, typically by using the hash or checksum, to determine if the content has changed. If so, then a new version number is assigned, in this case, it would be the youngest version in the hierarchy plus one. In addition, the parent and child pointers in the hierarchy would be updated in order to complete the insertion of the new file. Where the modification time stamp is not the youngest, then the process exits and may enter the process of sorting the entire hierarchy, as explained above. If the youngest file and the scanned file have the same hash, they are the same document and either an error message can be displayed or a dialogue box to the user in order to solicit further instructions from the user. Note that if the Document Name or file directory is not known, or not assigned to the new file, the system can solicit the user through the UI in order to have the user input a Document Name or file directory location for it. This may be presented to the user by presenting the most recently used document names, or a set of document names associated with a group of document names that are related, for example, as being part of a transaction. This grouping may be accomplished by an additional entry in a document hierarchy data structure element that identifies the group of documents. In yet another embodiment, the incoming file can be scanned for keywords, and those keywords used to scan yet another entry in the element of the data structure, which is the keywords for the documents in the hierarchy, or documents in the group. This generates suggestions that may be displayed to the user for selection. For example, if a group of documents is associated with the keyword “Whiteacre Transaction”, and a scan of an incoming file identifies the string “Whiteacre” several times in the agreement, then “Whiteacre” would be presented to the user as the top choice for the keywords, file directory and the document name.

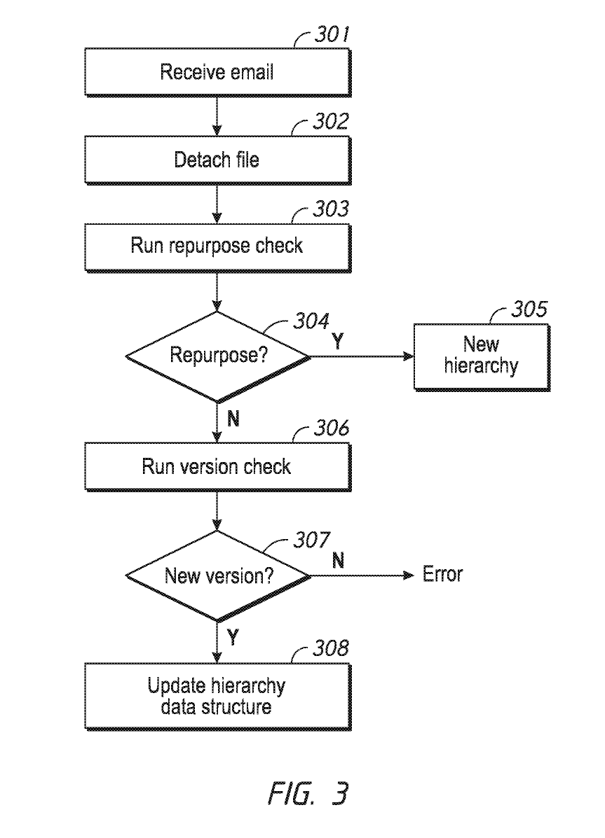

Another inference rule, relating to files transferred by email, might be described as follows:
If a file is discovered as an attachment to an email that was received from a particular email address and a file with the same name was previously sent to that email address in the last 30 days, then the file attached to the incoming email is likely to be a new version of the file attached to the sent email.
   The above rule could be further enhanced by checking that the two emails were in the same conversation thread and dealing with the case where the filename has been modified in the returned message (for instance ‘Draft Contract.doc’ becomes ‘Final Contract.doc’). This inference rule may also be implemented by a Boolean logic rule applied to a data structure representing the files and the email address. In one embodiment, a rolling list of email address sources for the last 30 days (or some other predetermined period of time) may be maintained as its own file in order to search for the presence or absence of that email address. The overall process would trap the command to detach and save the document, or would do that automatically. An example process is shown in FIG. 3. The email is received by the system (301). The file is detached from the message (302). Then the repurposing logic is applied to the metadata associated with the file (303). If there is a repurpose, then a new hierarchy is created (305). If not, then a version check is run (306). If there is a new version detected, (307), then the hierarchy is updated to include a new data element for this received file and the version values in the hierarchy are updated accordingly. (308). If this is done for all incoming emails, the data structure encoding the file hierarchy may include in its element for file F 1, an entry F1.emailsource, which contains the source email address. The process that intercepts the incoming email may search the hierarchy using logic commands, shown in pseudo-code:
   If (F2.emailsource=F1.recipient and F1.sender=username and F2.filename=F1. filename and F1.checksum < > F2.checksum) then set F2.parent to F1 and F2.version to F1.version+1;
   In this example, the “recipient” is of the email message transmitted by the user containing the file, for example, for further review. That recipient, if they send a reply back, is now the emailsource. When the file was sent to the recipient, the username is saved in the data structure as the sender of the file. If the filenames match or are determined to be sufficiently the same, yet the contents are different, then the returning file F2 is a child of F 1, so the “parent” of F2 is F1, and the version number of F2 is one above the version number of F1. Note that by using pointers to insert F2 into the hierarchy, it is possible to insert scanned files into parts of the hierarchy that have already been organized and stored by simply updating the pointers, rather than moving the contents of the data structure.

Other inference rules are subtler, for instance for Microsoft Word documents contain revision sequence ID values (RSIDs) that are used to improve the accuracy of document merge operations—these can be used to determine version genealogy with a high degree of confidence, which is discussed by U.S. patent application Ser. No. 14/980,173, incorporated herein.

### Re-Purposing Detection

Document re-purposing is an important part of the document workflow for most information workers. Document re-purposing typically involves taking a copy of a document that has been written for one purpose (or one client) and editing it to be suitable for a different purpose (or a different client).

From the point of view of the Inference Engine, document re-purposing is simple the creation of a new version of an existing document and is likely to be detected as such, particularly by inference rules that examine the content of the document such as one involving Revision Sequence or version IDs as described above. This is not, however likely to be helpful to the user of the software who considers the re-purposed document to be a separate entity. Re-purposing detection helps to solve this problem.

It would be possible to include re-purposing detection as part of the inference engine or part of the inference rules that it uses, but this is not the preferred approach as it would lead to further complexity in those components of the system. An alternate approach which provides a cleaner design is to have a separate re-purposing detection component which scans newly connected versions of documents for signs of possible re-purposing and then detaches from the version hierarchy those that are considered to be re-purposed.

Re-purposing detection is designed in a similar way to the inference engine—i.e. a set of re-purposing rules that can each spot a single pattern of likely document re-purposing and a re-purposing detection engine that applies the rules to each target and takes action if the sum of the scores returned by the applied rules exceeds a certain threshold. A simple re-purposing detection rule may be described as follows:
If a newly edited version of a file is found with a different name in a folder where it has not been found before then it is likely to be a case of document re-purposing so a predetermined score is assigned to the file. The score would be given a higher value if the time difference between the new version of the file and the previous version of the file exceeds three months or some other predetermined value.
   Giving a higher score when the newly edited document is based on a document that is over 3 months old (or some other predetermined period of time) reflects the fact that frequent changes to a document tend to indicate its use in an ongoing project whereas long periods with no edits followed by activity are more likely to indicate re-purposing in a new project.

In the case that the score for re-purposing detection for a particular file version fails to reach the defined threshold for automatic detachment, but exceeds another, lower, scoring threshold the system may record in the database the fact that re-purposing is a possibility and cause the UI to present the user with a question asking them whether they are re-using the document at some later point in time. If the user indicates by input into the system that the document is being re-purposed the detachment action can be taken at that point, and a new hierarchy for the new document created.

### User Interface

The user interface of the system attempts to display information about the files that have been scanned and the additional information that the system has derived by use of the Inference Engine and Re-purposing detection engines.

One aspect of the user interface is to show a list of documents that the user has worked with or used recently, ordered with the most recently accessed documents at the head of the list. Note that the concept of a document is distinct from the concept of a file in this context. A document is a higher-level concept and should be thought of as ‘The Sales Contract’ whereas a document file is ‘C:\Documents\ Sales Contract.docx’. A document has one or more versions (multiple versions indicating the history of the content as it is edited). Each version has one or more associated files (multiple files when there is more than one copy of the same version in different locations—for example on disk and in a sent email).

Another aspect of the user interface is to show a list of documents based on a search initiated by the user. Aspects that might be searched include file names, names of locations (including folder names, email subjects), people who are related to a document and document content.

The document list—either resulting from a search or the most recently used list may be filtered by the user—filter aspects might include document location (i.e. on disk, in email, on Google Drive), by person (i.e. only documents that the user has shared with or received from a particular other user), by date or by other aspects. The ability to filter by these aspects helps the search support the natural processes by which users remember the files they are looking for—i.e. a user ay not remember the exact file name, but may recall that he received it from another person at an approximate time in the past or range of time.

When a list of documents is shown to the user they may select any of the documents by an action such as clicking on the document to cause the UI to show further detail about the history and versions of the selected document. Possible arrangements for the further detail display include
A list of events—in chronological order with the most recent at the top—that relate to that document—for instance events might include edited, copied, received via email, shared via Google Drive, etc. This event list can be generated from the scanning history associated with the document in the database.
A version tree for the document showing how different versions of the document relate to each other and where they are located. This can be generated from the document version genealogy stored in the database along with the scanning history associated with the document and its versions in the database.
   It user interface may provide an option for the user to switch between these two views of the detailed information about the document.

In certain situations, the user may already be focusing on the context of a particular document—for instance they may have opened a file in Microsoft Word and that file may have been identified by the system as part of a document genealogy containing several versions. In these circumstances, only the document detail view will be shown to the user, allowing them to see the history of or the version tree of the document in context in which they are working (possibly as an Add-in to Microsoft Word or a similar application). The system may also provide helpful summary information to the user such as ‘Did you know that there is a newer version of this document in your email?’.

### System Controller

The system control component is responsible for scheduling the activation of the various other components and making the data from the database available to the UI component. In order to minimize resource usage (and avoid shortening battery life on laptops and other portable devices) it is desirable for the system controller to only activate components when there is work to be done—for instance the inference engine should only be activated after new content has been added to the database by one or more of the repository scanners and the re-purposing detection should only be activated if the inference engine has successfully connected at least one new file as a version of an existing document.

In the current implementation of the product, the UI is implemented as a set of web pages in HTML and JavaScript, which are served by a local web server component built into the system controller. This local web server also serves data from the database to allow the UI to display the content that is required. This is however just an example of how the UI could be implemented and how the system controller could provide the data the data to the UI.

Operating Environment: The system is typically comprised of a central server that is connected by a data network to a user's computer. The central server may be comprised of one or more computers connected to one or more mass storage devices. The precise architecture of the central server does not limit the claimed invention. Further, the user's computer may be a laptop or desktop type of personal computer. It can also be a cell phone, smart phone or other handheld device, including a tablet. The precise form factor of the user's computer does not limit the claimed invention. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like. The precise form factor of the user's computer does not limit the claimed invention. In one embodiment, the user's computer is omitted, and instead a separate computing functionality provided that works with the central server. In this case, a user would log into the server from another computer and access the system through a user environment.

The user environment may be housed in the central server or operatively connected to it. Further, the user may receive from and transmit data to the central server by means of the Internet, whereby the user accesses an account using an Internet web-browser and browser displays an interactive web page operatively connected to the central server. The central server transmits and receives data in response to data and commands transmitted from the browser in response to the customer's actuation of the browser user interface. Some steps of the invention may be performed on the user's computer and interim results transmitted to a server. These interim results may be processed at the server and final results passed back to the user.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory. The IO devices can include a display screen, loudspeakers, microphone and a movable mouse that indicate to the computer the relative location of a cursor position on the display and one or more buttons that can be actuated to indicate a command.

The computer can display on the display screen operatively connected to the I/O circuitry the appearance of a user interface. Various shapes, text and other graphical forms are displayed on the screen as a result of the computer generating data that causes the pixels comprising the display screen to take on various colors and shades. The user interface also displays a graphical object referred to in the art as a cursor. The object's location on the display indicates to the user a selection of another object on the screen. The cursor may be moved by the user by means of another device connected by I/O circuitry to the computer. This device detects certain physical motions of the user, for example, the position of the hand on a flat surface or the position of a finger on a flat surface. Such devices may be referred to in the art as a mouse or a track pad. In some embodiments, the display screen itself can act as a trackpad by sensing the presence and position of one or more fingers on the surface of the display screen. When the cursor is located over a graphical object that appears to be a button or switch, the user can actuate the button or switch by engaging a physical switch on the mouse or trackpad or computer device or tapping the trackpad or touch sensitive display. When the computer detects that the physical switch has been engaged (or that the tapping of the track pad or touch sensitive screen has occurred), it takes the apparent location of the cursor (or in the case of a touch sensitive screen, the detected position of the finger) on the screen and executes the process associated with that location. As an example, not intended to limit the breadth of the disclosed invention, a graphical object that appears to be a 2 dimensional box with the word “enter” within it may be displayed on the screen. If the computer detects that the switch has been engaged while the cursor location (or finger location for a touch sensitive screen) was within the boundaries of a graphical object, for example, the displayed box, the computer will execute the process associated with the “enter” command. In this way, graphical objects on the screen create a user interface that permits the user to control the processes operating on the computer.

The invention may also be entirely executed on one or more servers. A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, TCP, UDP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application. The precise architecture of the central server does not limit the claimed invention. In addition, the data network may operate with several levels, such that the user's computer is connected through a fire wall to one server, which routes communications to another server that executes the disclosed methods.

The user computer can operate a program that receives from a remote server a data file that is passed to a program that interprets the data in the data file and commands the display device to present particular text, images, video, audio and other objects. The program can detect the relative location of the cursor when the mouse button is actuated, and interpret a command to be executed based on location on the indicated relative location on the display when the button was pressed. The data file may be an HTML document, the program a web-browser program and the command a hyper-link that causes the browser to request a new HTML document from another remote data network address location. The HTML can also have references that result in other code modules being called up and executed, for example, Flash or other native code.

Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

In some instances, especially where the user computer is a mobile computing device used to access data through the network the network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP),or Unlicensed Mobile Access (UMA).

The Internet is a computer network that permits customers operating a personal computer to interact with computer servers located remotely and to view content that is delivered from the servers to the personal computer as data files over the network. In one kind of protocol, the servers present webpages that are rendered on the customer's personal computer using a local program known as a browser. The browser receives one or more data files from the server that are displayed on the customer's personal computer screen. The browser seeks those data files from a specific address, which is represented by an alphanumeric string called a Universal Resource Locator (URL). However, the webpage may contain components that are downloaded from a variety of URL's or IP addresses. A website is a collection of related URL's, typically all sharing the same root address or under the control of some entity. In one embodiment different regions of the simulated space have different URL's. That is, the simulated space can be a unitary data structure, but different URL's reference different locations in the data structure. This makes it possible to simulate a large area and have participants begin to use it within their virtual neighborhood.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as C, C++, C#, Action Script, PHP, EcmaScript, JavaScript, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. In one embodiment, the relational database may be housed in one or more operatively connected servers operatively connected to computer memory, for example, disk drives. In yet another embodiment, the initialization of the relational database may be prepared on the set of servers and the interaction with the user's computer occur at a different place in the overall process.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention as defined by the following claims.

What is claimed:

1. A computer system for managing versions of a document comprised of at least one file representing at least one corresponding version of the document comprising:
a module comprised of logic adapted generate a document hierarchy data structure representing a revision history of the document by use of data embodying inference rules that are applied to metadata corresponding to the at least one files; and
a computer memory that stores the the generated hierarchical data structure representing the document revision hierarchy.

2. A process executed by a computer system on a plurality of document data files each representing a corresponding different version of a document, said computer system further comprised of a memory storing a data structure encoding the version hierarchy of the document comprising:
detecting a new file;
obtaining at least one metadata value describing one corresponding characteristic of the new file, said metadata comprising a modification date of the new file;
determining a repository location associated with the new file;
determining the modification date of the youngest file in the determined file directory;
determining that the modification date of the new file is later than the determined modification date of the youngest file;
in dependence on the determining that the modification date of the new file is later, creating a new data element in the data structure representing the hierarchy;
storing a pointer in a data element corresponding to the older file to the created data element associated with the younger file; and
storing in the new data element a pointer to the younger file.

3. A computer system adapted by logic for organizing a plurality of related document files in a version hierarchy, said plurality of document files being different versions of a document, and said plurality of document files being stored in one or more document repositories, comprising:
a repository scanning module adapted by logic to scan the one or more document repositories to detect either new, newly detected or newly changed document files comprising the plurality of related document files;
a database adapted by logic to store a data structure representing a version hierarchy of the document, said data structure further comprised of metadata about the document files detected by the repository scanning module;
an inference module adapted by logic to determine the proper location in the version hierarchy of each of the detected document files by use of at least one encoded inference rules.

4. The system of claim 3 where the one or more repositories are comprised of: a folder on a local computer operating the scanner module, a DMS system accessed externally to the local computer, a folder directory on a remote network storage device, or a location on a remote file storing or sharing system.

5. The system of claim 3 where the inference module is further adapted to obtain a first metadata about a first file of the plurality of document files, obtain a second metadata about a second file of the plurality of document files, apply at least one inference rule to the first and second metadata, and in dependence on the inference rule result, modify a first data element corresponding to the first file and a second data element corresponding to the second file to store a reference in the first data element designating that the second data element is a child to the first data element, said first and second data elements comprising the version hierarchy data structure.

6. The system of claim 3 further comprising:
a re-purposing detection module adapted by logic determine that a first document file detected by the scanning module is the same as a second document file, and that the second document file is a re-purposed document and not a new version of the document.

7. The system of claim 6 where the re-purposing detection module is further adapted to create a new data structure representing a version hierarchy for a new document, said data structure comprised of a data element corresponding to the re-purposed document.

8. The system of claim 3 further comprising:
a user interface module that is adapted by logic to display on the computer display screen data representing at least part of the version hierarchy.

9. The system of claim 5 further comprising:
a user interface module that is adapted by logic to solicit from a user metadata about the first or second file.

10. The system of claim 3 where the version hierarchy data structure is organized as a tree data structure.

11. The system of claim 3 where the version hierarchy data structure is organized as a linked list.

12. The system of claim 8 where the user interface module is further adapted to display a chronological list of events that relate to the document.

13. The system of claim 8 where the user interface module is further adapted to display a version tree diagram.

14. The system of claim 3 further comprising:
an office productivity module adapted to edit a document file comprising the plurality of document files;
a warning module adapted by logic to obtain from the office productivity module a metadata describing the document file and to interrogate the database using the obtained metadata data in order to detect the condition either that a user of the office productivity module is not editing the latest version of the document or that there are other document files corresponding to other versions of the document whose corresponding locations on version hierarchy are different branches and not lineally related.

15. The system of claim 3 where the one or more repositories is comprised of at least one stored received email message with at least one file attachment that is one of the plurality of document files.

16. The system of claim 15 where the metadata about the at least one file attachment is comprised of metadata describing the email message.

17. The system of claim 16 where the metadata describing the email message is one of sender, recipient, receipt date.

18. The system of claim 5 where the metadata describing the first and second document files is comprised of one of: filename, modification timestamp, latest author, originating author, detection timestamp, keywords, file system directory location.

19. The system of claim 3 where the encoded inference rule is:
If a first document file comprising the plurality of document files is associated with a file system directory path that is the same as that associated with a second file comprising the plurality of document files that is already a part of the document version hierarchy, and a first metadata corresponding to the first document file is comprised of a younger modification timestamp than a second metadata associated with the second file and the contents of the first file is different than the contents of the second file, then the first file is determined to be a new version of the document.

20. The system of claim 3 where the inference rule is:
If a first file is detected as an attachment to a first email message, and an email sender data for the first email message is the same as a recipient data for a second, earlier email message that included a second file as an attachment that was a version of a document, and a filename of the first file and a filename of the second file are determined by logic to have a similarity score at or above a predetermined threshold, then the first file is determined to be a new version of the document.

21. The system of claim 20 where the inference rule is further conditioned on the test that the first email message was received within a predetermined period of time from the transmission of the second email message.

22. The system of claim 6 where the re-purposing module is further adapted to utilize an inference rule that is:
If the a first document file is detected by the scanner in a file system location that is different than a second document file that occupies a position in the version hierarchy and the contents of the first document file is the same as the second document file, then it is determined that first document file is a repurposed document file.

23. The system of claim 22 where the inference rule is further comprised of detecting the condition that a creation timestamp of the first file is greater than a predetermined period of time from the modification timestamp of the second document file.

24. The system of claim 3 where the first and second metadata are revision sequence ID values of the first and second document, respectively.

25. The system of claim 3 further adapted by logic to activate the repository scanning module whenever the system detects a modification of one of the plurality of document files and its storage as a new file.

26. The system of claim 25 further adapted by logic to create a new data element in the version hierarchy data structure in response to the detection of the modification and storage as a new file.

27. The system of claim 3 further adapted to poll an on-line repository periodically to obtain changes to metadata of files stored in the on-line repository.

28. The system of claim 3 where the document repository is one of: a file system directory, Document management system, an external on-line repository accessed using a URL, a plurality of stored email messages with at least one email message being comprised of at least one attachment comprised of at least one of the document files.
